(19) United States
(12) Patent Application Publication
(10) Pub. No.: US 2026/0208557 A1
(43) Pub. Date: Jul. 23, 2026

(54) METHOD FOR CONTROLLING A CLIMATE CONTROL SYSTEM OF A VEHICLE

(71) Applicant: FCA US LLC, Auburn Hills, MI (US)

(72) Inventors: Vivek Trivedi, Chennai (IN); Nilesh Shridhar Mirajkar, Chennai (IN)

(21) Appl. No.: 19/027,416

(22) Filed: Jan. 17, 2025

(51) Int. Cl. B60H 1/00

(52) U.S. Cl. CPC B60H 1/00735

(57) ABSTRACT

A method for controlling a climate control system of a vehicle may include determining that a climate control system of a vehicle is operating, determining that a door or a window of the vehicle is at least partially open, and one or both of sending a communication indicative that the door or window is at least partially open, or altering an output of the climate control system. The climate control system may include a cooling system capable of lowering the temperature of the passenger cabin of the vehicle and a heating system capable of increasing the temperature of the passenger cabin of the vehicle.

### FIELD

The present disclosure relates to a method for controlling a climate control system of a vehicle.

### BACKGROUND

Traditionally, vehicles equipped with an automatic climate control system rely on a temperature sensor within the passenger compartment of the vehicle to detect temperature changes within the passenger compartment and base adjustments in the climate control system at least in part on this temperature. However, some vehicles do not have a temperature sensor within the passenger compartment and even vehicles that have a temperature sensor within the passenger compartment may have a delayed response in adjusting the climate control system due to, for example, a delay between ambient air entering the passenger compartment through an open door or window and a temperature change reaching or being detected by the temperature sensor within the passenger compartment. Open windows or doors can negatively impact the intended temperature change that is intended to be achieved by the climate control system.

### SUMMARY

In at least some implementations, a method for controlling a climate control system of a vehicle may include determining that a climate control system of a vehicle is operating, determining that a door or a window of the vehicle is at least partially open, and one or both of sending a communication indicative that the door or window is at least partially open, or altering an output of the climate control system.

In at least some implementations, sending a communication indicative that the door or window is at least partially open includes communicating through a user interface, including an infotainment system or digital gauge cluster, or an external device, including a mobile phone or computer.

In at least some implementations, altering an output of the climate control system is based at least partially on one or more doors and/or windows of the vehicle being at least partially open.

In at least some implementations, determining one or more doors or windows of the vehicle is at least partially open includes determining a position of each of the one or more doors or windows of the vehicle that is at least partially open, and the step of altering the output of the climate control system is based at least partially on the position of each of the one or more doors or windows of the vehicle at least partially open.

In at least some implementations, altering an output of the climate control system is at least partially based on one or both of an ambient temperature outside of the vehicle and a solar load.

In at least some implementations, the ambient temperature is above a target temperature, the output of a cooling system is increased, or when the ambient temperature is below the target temperature, the output of a heating system is increased.

In at least some implementations, determining one or more doors or windows of the vehicle is at least partially open includes determining a position of each of the one or more doors or windows of the vehicle that is at least partially open, and the output of the climate control system is adjusted based at least partially on the position of each of the one or more doors or windows of the vehicle at least partially open.

In at least some implementations, altering the output of the climate control system is further based at least partially on an output from a passenger compartment temperature sensor.

In at least some implementations, altering an output of the climate control system is at least partially based on one or more of the ambient temperature outside of the vehicle, the solar load, and/or a temperature of the passenger.

In at least some implementations, a vehicle includes one or more doors and windows configured to move between an open and closed position, one or more door position sensors and window position sensors configured to detect when one or more of the one or more doors and windows are at least partially open, a climate control system having one or both of a heating system and a cooling system, the heating system capable of increasing a temperature of a passenger compartment, the cooling system capable of decreasing the temperature of the passenger compartment, a control system that includes one or more processors, memory, and instructions or programs stored in the memory or otherwise accessible by the processors that is capable of determining that a climate control system of a vehicle is operating, determining that a door or a window of the vehicle is at least partially open, and one or both of the following, a) sending a communication indicative that the door or window is at least partially open, or b) altering an output of the climate control system.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a schematic of a vehicle with a climate control system; and

FIG. 2 is a flowchart depicting a method for controlling the climate control system of FIG. 1.

### DETAILED DESCRIPTION

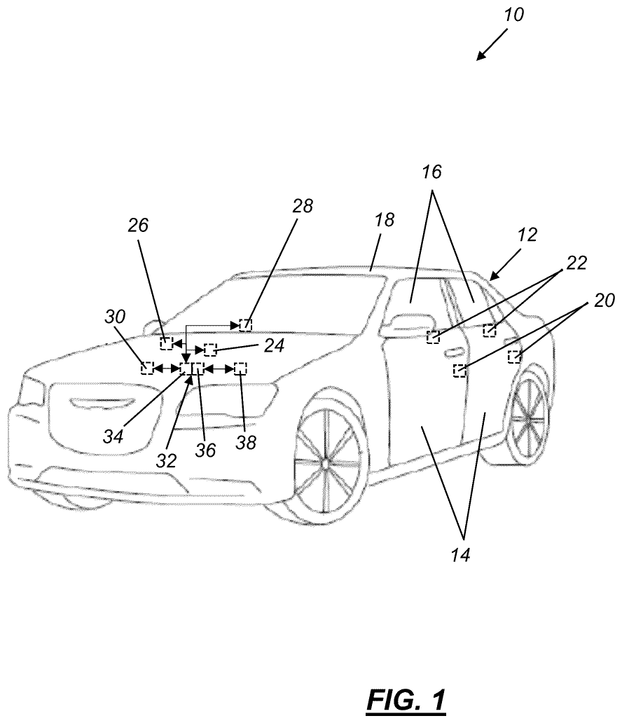

Referring in more detail to the drawings, FIG. 1 shows a vehicle 10 with a body 12 having an interior and an exterior. At least part of the interior includes a passenger compartment that is configured to receive vehicle occupants. Doors 14 and windows 16 may be part of the body 12, define part of the passenger compartment, and may be moved between open and closed positions to provide access to the passenger compartment between the exterior and interior of the vehicle 10. The doors 14 may be pivotably opened and may include locks by which the doors 14 can be locked in the closed position. The doors 14 may be opened manually or may be powered by an actuator which may be a pneumatic, hydraulic, or include or be defined by one or more electric motors. The windows 16 may be mounted to or near the doors 14 or a roof 18 of the vehicle 10. The windows 16 may be slidably moved between open and closed positions or pivotably mounted between open and closed positions, depending on the implementation. Movement of the windows 16 may be done manually by a vehicle occupant or may be automated by an actuator such as an electric motor. When all of the doors 14 and windows 16 are in the closed position, the passenger compartment is substantially closed off from the ambient environment outside the vehicle 10.

Each door 14 may have a door position sensor 20 configured to detect or track the position of one or more doors 16 of the vehicle 10. The door position sensor 20 may be a switch, a hall-effect sensor, optical sensor, or other sensor. In some embodiments, the door position sensor 20 can determine whether the door 14 is in the closed position. So that, when the door 14 is in the closed position, the door position sensor 20 outputs an electrical signal indicating the door 14 is in the closed position. When the door 14 is moved from the closed position, the door position sensor 20 may not output an electrical signal. These functions may be reversed, so that the door position sensor 20 outputs a signal when the door 14 is open (to any extent, in at least some implementations) and does not output an electrical signal when the door 14 is in the closed position. Furthermore, the door position sensor 20 may output a first electrical signal when the door 14 is in the closed position and a second electrical signal, different from the first electrical signal, when the door 14 is open. In other embodiments, the door position sensor 20 may determine an instantaneous position of the door 14 when the door 14 is between the closed and open positions by tracking the position of the door 14 and outputting a specific electrical signal corresponding to the position of the door 14 between the closed and open positions. For example, the degree of pivot may be determined by the door position sensor 20 or just whether the door is fully closed or not. That is, the extent to which the door 14 is open may be determined in some implementations, and in other implementations, if the door 14 is open to any extent the output of the door position sensor 20 is the same and does not vary based on the amount that the door 14 is open.

Each window 16 may have a window position sensor 22 configured to detect or track the position of one or more windows 16 of the vehicle 10. The window position sensor 22 may be configured to detect and track movement of the window 16 itself or movement of part of a drive system that moves the window 16, and may include or be defined by a switch, a potentiometer, a hall-effect sensor, an optical sensor, or other sensor. So the term “sensor” may include any mechanism capable of determining that a window is at least partially open or the position of the window). In some embodiments, the window position sensor 22 is configured to detect when the window 16 is in the closed position. Like the door position sensor 20, the window position sensor 22 may output electrical signals corresponding to the window 16 being in a closed or open position. In other implementations, like the door position sensor 20, the window position sensor 22 may be configured to determine an instantaneous position of the window 16 when the window 16 is between the closed and open positions (i.e. the amount that or extent to which the window is open) and the window position sensor 22 may output specific electrical signal corresponding to the position of the window 16 between the closed and open positions. That is, the precise position of the window 16 between completely open and closed may correspond to the size of the gap that exposes the passenger compartment to ambient air may be output by the window position sensor 22.

The vehicle 10 may have a solar load sensor 24 positioned on the body 12 of the vehicle 10 or within the passenger compartment of the vehicle 10, and configured to detect the intensity of sunlight entering the vehicle 10 through the windows 16. The solar load sensor 24 may be any sensor capable of measuring the intensity of sunlight (e.g. radiant energy from the sun), including a photodetector capable of converting solar radiation into an electrical signal output that varies based on strength of the solar radiation.

To determine the temperature outside the vehicle, an ambient temperature sensor 26 may be positioned separate from the passenger compartment on or within the vehicle 10 to determine the temperature of ambient air outside of the passenger compartment. Upon determining the ambient temperature, the ambient temperature sensor 26 may output an electrical signal that varies based on the temperature of the ambient air outside the vehicle 10.

Depending on the implementation, the vehicle may or may not have a passenger compartment temperature sensor 28 to determine the temperature of air within the passenger compartment of the vehicle 10. If equipped, the passenger compartment temperature sensor 28 may output an electrical signal that varies based on the temperature of air within the passenger compartment.

To enable heating or cooling of the passenger compartment, the vehicle 10 has a climate control system 30 positioned within the body of the vehicle including one or both of a cooling system and a heating system. The cooling system may be any system configured to reduce the air temperature in the passenger compartment and the heating system may be any system configured to increase the air temperature in the passenger compartment. As an example, the cooling system and the heating system may use a blower to blow chilled air from a cooling source or heated air from a heat source through one or more vents positioned throughout the passenger compartment of the vehicle 10.

To control operation of the climate control system 30 and other vehicle systems and components, the vehicle 10 has a control system 32. The control system 32 includes one or more controllers or processors, memory and instructions or programs stored in the memory or otherwise accessible by the processor(s). In some implementations, the control system 32 may have or be defined by a plurality of vehicle controllers independent or networked to each other. Each of the controllers may communicate with one or more vehicle components or system components. The control system 32 may include a climate system controller 34 and a body control module (BCM) 36. The climate system controller 34 may be configured to receive signals from one or more of the door position sensors 20, window position sensors 22, solar load sensor 24, ambient temperature sensor 26, and/or the passenger compartment temperature sensor 28 (if equipped), and various other sensors such as a humidity sensor, to adjust one or more components or aspects of the climate control system 30 based at least partially on the signals received. The BCM 36 may be in communication with, among other things, a user interface 38 configured to communicate with and accept input from vehicle occupants to control vehicle functions.

The user interface 38 may be part of a vehicle infotainment system or a digital gauge cluster, and may include a display visible by one or more vehicle occupants within the interior of the vehicle 10. The control system 32 may be in communication with the user interface 38 to provide various multimedia and information to vehicle occupants, and to provide the user interface 38 by which a user can enter information via the display or related inputs. In at least some implementations, user input via the user interface 38 may be provided through a touch-sensitive display, allowing vehicle occupant(s) to navigate through menus, adjust vehicle settings, and control features by tapping or swiping on the touchscreen. Some implementations may utilize physical controls to recognize vehicle occupant input such as button, knobs, or dials positioned within the interior of the vehicle 10. Other implementations may use voice recognition through integrated voice control systems allowing vehicle occupant(s) to operate vehicle functions using voice commands.

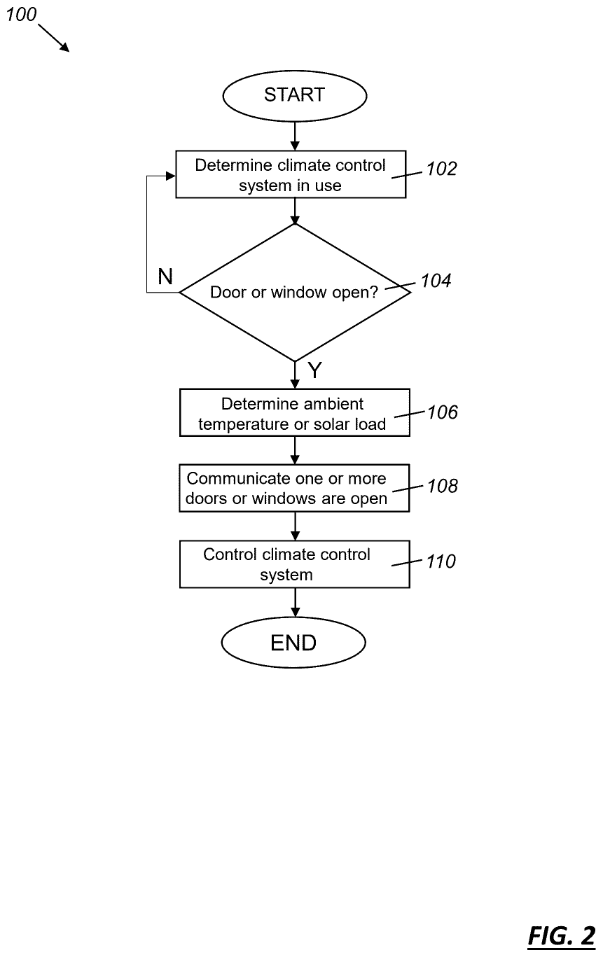

As shown in FIG. 2, a method 100 for controlling a climate control system 30 of a vehicle 10 may include a step 102 of determining that the climate control system 30 is on/in use. The control system 32, either the climate system controller 34 or the BCM 36, may determine that either the cooling system or the heating system is currently in use to adjust the temperature of the passenger compartment. This may be determined in different ways, such as detecting operation of the blower associated with heating or cooling, or by determining operation of the climate control system 30 by a vehicle occupant via the user interface 38, or by operation of a condenser of the cooling system or by a vehicle user prior to entering the vehicle via an external device such as a mobile phone that is communicated with the control system 32 (e.g. by a suitable app and communications network).

If in step 102 it is determined that the climate control system 30 is in use, the method 100 advances to step 104. In step 104, it is determined whether a door 14 or a window 16 of the vehicle 10 is at least partially open. The control system 32 may use signals from the door position sensors 20 and the window position sensors 22 to determine the positions of the doors 14 and windows 16. Depending on the implementation, the control system 32 may determine that one or more of the doors 14 and windows 16 are at least partially open (i.e. not closed), or may determine a specific position (i.e. magnitude or amount open) of any doors 14 and windows 16 that are open. The specific position relative to the completely open and closed position may be output by the door position sensors 20 and window position sensors 22 and received by the control system 32. For example, a door 14 may have a maximum degree of pivot in the completely open position. The precise degree of pivot may be determined by the door position sensor 20 and output to the control system 32. Likewise, when a window 16 is in the completely open position, the passenger compartment may be exposed to ambient air through a gap of a certain area. The window 16 may be any position in between completely open and closed, changing the area of the gap that exposes the passenger compartment to ambient air. The precise position of the window 16 between completely open and closed may be output by the window position sensor 22 and used by the control system 32 to determine the size of the gap that exposes the passenger compartment to ambient air.

In step 106, an ambient temperature of air surrounding the vehicle 10, a solar load at or near the vehicle 10, or both the ambient temperature and the solar load are determined. As noted previously, the control system 32 may receive inputs indicative of the ambient temperature, the solar load, or both the ambient temperature and the solar load from the ambient temperature sensor 26 and/or the solar load sensor 24. In some implementations, the control system 32 may also determine a passenger compartment temperature using the passenger compartment temperature sensor 28 (if equipped, and if used). Further, information from additional sensors may also be used, if available and if desired in different implementations.

In step 108, the control system 32, possibly via the BCM 36, communicates to a user when one or more doors 14 or windows 16 are at least partially open and the climate control system 30 is on. The communication may be through the user interface 38 (e.g. an infotainment system or a digital gauge cluster) or an external device (e.g. a mobile phone or computer). The form of communication may be text/digital message on a display within the vehicle 10 or on the external device, an audible message through a speaker, or other form of communication to the user. It may be desirable to communicate to the user that one or more doors 14 or windows 16 are open when the climate control system 30 is in use because ambient air that enters the passenger compartment mixes with the air in the passenger compartment and can alter the temperature of the passenger compartment when there is a difference between the ambient temperature and the passenger compartment temperature. This may cause undesirable or uncomfortable temperature change within the passenger compartment, may be contrary to the passenger compartment temperature change that is intended by use of the climate control system 30, can waste energy used to operate the climate control system 30 and may cause the climate control system 30 to operate at a greater level to combat the effects of the ambient air flowing into the passenger compartment. Thus, by communicating to the user, the user may choose to close the one or more doors 14 or windows 16, or at least the user will be aware that the open window(s) 16 or door(s) 14 could be having a negative effect on the passenger compartment temperature and/or climate control system 30 effectiveness or efficiency.

In addition to communicating to the user, the method 100 may also, in step 110, alter the operation or output of the climate control system 30 when a door 14 or window 16 is open and the climate control system 30 is operating. The output of the climate control system 30 may be increased or decreased, as desired, and whether the output is increased or decreased may be determined based on one or more factors. By way of non-limiting examples, the climate control system 30 may be controlled as a function of one or more of a desired or target passenger compartment temperature, current passenger compartment temperature, ambient temperature, solar load, position of one or more windows 16 or doors 14 (e.g. more windows 16 being open or a window 16 that is more fully open may provide greater inflow of ambient air), and the like. The target temperature may be set by a user of the vehicle 10 using the user interface 38 or may be set by the climate system controller 34 based on predetermined programming.

In one non-limiting example, the climate control system 30 may be controlled based upon a magnitude of difference between the ambient temperature relative to the target temperature. If the ambient temp is above the target temperature, the output of the cooling system may be increased or the output of the heating system may be decreased by adjusting one or more components of the cooling system or heating system, to account for or offset the warmer ambient air entering the passenger compartment. By way of non-limiting examples, if the cooling system is being used, the blower fan speed may be increased, and if the heating system is being used, the blower fan speed may be decreased. By increasing the output of the cooling system or decreasing the output of the heating system, the climate control system counters the warmer air entering the passenger compartment through the at least partially open door or window.

Conversely, if the ambient temperature is below the target temp, the output of the heating system may be increased or the output of the cooling system decreased, by adjusting one or more components of the heating or cooling systems to account for colder ambient air entering the passenger compartment. By way of non-limiting examples, if the heating system is being used, the blower fan speed may be increased and if the cooling system is being used, the blower fan speed may be decreased. By increasing the output of the heating system or decreasing the output of the cooling system, the climate control system 30 counters any colder air entering the passenger compartment through the at least partially open door 14 or window 16.

The solar load intensity determined from the solar load sensor 24 may be used by itself or in combination with the ambient temperature to control the climate control system 30. If the solar load intensity determined by the solar load sensor 24 is above a predetermined intensity the control system 32 may increase the output of the cooling system or decrease the output of the heating system to offset the effect of the solar heating of the passenger compartment. This may be accomplished by controlling one or more components of the heating system or the cooling system as previously described herein.

Furthermore, the magnitude of the difference between the ambient temperature and the target temperature, or the magnitude that the solar intensity is above the threshold, may be used by the control system 32 to determine the amount to increase or decrease the cooling system or the heating system. For example, a larger difference between the ambient temperature and the target temperature, or the solar intensity and the threshold, may require a larger increase or decrease in output from one or more of the components of the cooling system and the heating system to achieve or maintain a temperature or temperature range of the passenger compartment.

More than one window 16 or door 14 may be simultaneously at least partially open. This may be detected by the control system 32 when multiple window position sensors 22 or door position sensors 20 indicate that multiple windows 16 or doors 14 have left the closed position. To account for potentially greater inflow of ambient air into the passenger compartment, the control system 32 may increase the output of either heating system or cooling system relative to when a single window 16 or door 14 is at least partially open. Similar controls may be implemented based on the magnitude that one or more doors 14 or windows 16 are open, with one or more doors 14 or windows 16 being more open potentially enabling greater inflow of ambient air.

In implementations without a passenger compartment temperature sensor 28, the systems and methods facilitate user intervention when a door 14 or window 16 is open, and/or provide improved control of the climate control system 34 to achieve greater passenger comfort. In implementations when the vehicle 10 is equipped with a passenger compartment temperature sensor 28, the control system 32 may control the climate control system 30 based at least partially on the passenger compartment temperature for improved passenger comfort. For example, the passenger compartment temperature may be used with the target temperature, the ambient temperature, the solar load, the quantity of doors 14 or windows 16 open, and/or the amount each door 14 or window 16 is open to control the heating system or the cooling system as previously described herein. Furthermore, if the target temperature and the ambient temperature are either both above or below the passenger compartment temperature, it is possible that opening one or more doors 14 or windows 16 may bring the passenger compartment temperature closer to the target temperature. In this scenario, the target temperature may be reached and/or maintained with less output from the heating system or the cooling system. Therefore, the control system 32 may reduce the output of either the heating system or the cooling system in anticipation of the ambient air mixing with the air within the passenger compartment to bring the passenger compartment temperature closer to the target temperature.

Detecting that one or more doors 14 or windows 16 are open allows for immediate adjustment of the climate control system 30, even in vehicles equipped with the passenger compartment temperature sensor 28. Because heat transfer between the ambient air and the climate-controlled air of the passenger cabin, climate control systems 30 relying only or mostly on readings from the passenger compartment temperature sensor 28 may have a delayed response to changing conditions within the passenger compartment. Depending on the location of the passenger compartment temperature sensor 28, it can take seconds or even minutes depending on the differential in temperature between the ambient air and the passenger compartment air and the amount of the passenger compartment exposed to ambient air by opening one or more doors 14 or windows 16 for a significant temperature change to reach the passenger compartment temperature sensor 28. Therefore, by determining one or more doors 14 or windows 16 are at least partially open and either the ambient temperature or the solar load (and/or information from other sensors that may be used for controlling the climate control system), the control system 32 can quickly respond to projected or actual changes in the temperature of the passenger compartment, without waiting for a significant temperature change to reach the passenger compartment temperature sensor 28.

What is claimed is:

1. A method for controlling a climate control system of a vehicle, comprising the steps of:
determining that a climate control system of a vehicle is operating;
determining that a door or a window of the vehicle is at least partially open; and
one or both of the following, a) sending a communication indicative that the door or window is at least partially open, or b) altering an output of the climate control system.

2. The method of claim 1, wherein sending a communication indicative that the door or window is at least partially open includes communicating through a user interface of the vehicle or of an external device.

3. The method of claim 1, wherein altering an output of the climate control system is based at least partially on one or more doors and/or windows of the vehicle being at least partially open.

4. The method of claim 3, wherein the step of determining one or more doors or windows of the vehicle is at least partially open includes determining a position of each of the one or more doors or windows of the vehicle that is at least partially open and the step of altering the output of the climate control system is based at least partially on the position of each of the one or more doors or windows of the vehicle.

5. The method of claim 3, wherein altering an output of the climate control system is at least partially based on one or both of an ambient temperature outside of the vehicle and a solar load.

6. The method of claim 5, when the ambient temperature is above a target temperature, the output of a cooling system is increased, or when the ambient temperature is below the target temperature, the output of a heating system is increased.

7. The method of claim 6, wherein the step of determining one or more doors or windows of the vehicle is at least partially open includes determining a position of each of the one or more doors or windows of the vehicle that is at least partially open, and the output of the climate control system is adjusted based at least partially on the position of each of the one or more doors or windows of the vehicle at least partially open.

8. The method of claim 1, wherein altering the output of the climate control system is further based at least partially on an output from a passenger compartment temperature sensor.

9. The method of claim 8, wherein altering an output of the climate control system is at least partially based on one or more of an ambient temperature outside of the vehicle, a solar load in the vehicle, and/or a temperature of the passenger compartment.

10. A vehicle, comprising:
one or more doors and windows each configured to move between an open and closed position;
one or more door position sensors and window position sensors configured to detect when one or more of the one or more doors and windows are at least partially open;
a climate control system having one or both of a heating system and a cooling system, the heating system capable of increasing a temperature of a passenger compartment, the cooling system capable of decreasing the temperature of the passenger compartment;
a control system that includes one or more processors, memory, and instructions or programs stored in the memory or otherwise accessible by the processors that is capable of determining that a climate control system of a vehicle is operating, determining that a door or a window of the vehicle is at least partially open, and one or both of the following, a) sending a communication indicative that the door or window is at least partially open, or b) altering an output of the climate control system.

11. The vehicle of claim 10, wherein sending a communication indicative that the door or window is at least partially open includes communicating through a user interface of the vehicle or of an external device.

12. The vehicle of claim 10, wherein altering an output of the climate control system is based at least partially on one or more doors and/or windows of the vehicle being at least partially open.

13. The vehicle of claim 12, wherein determining one or more doors or windows of the vehicle is at least partially open includes determining a position of each of the one or more doors or windows of the vehicle that is at least partially open, and the step of altering the output of the climate control system is based at least partially on the position of each of the one or more doors or windows of the vehicle at least partially open.

14. The vehicle of claim 12, wherein altering an output of the climate control system is at least partially based on one or both of an ambient temperature outside of the vehicle and a solar load in the vehicle.

15. The vehicle of claim 14, when the ambient temperature is above a target temperature, the output of a cooling system is increased, or when the ambient temperature is below the target temperature, the output of a heating system is increased.

16. The vehicle of claim 12, wherein determining one or more doors or windows of the vehicle is at least partially open includes determining a position of each of the one or more doors or windows of the vehicle that is at least partially open, and the output of the climate control system is adjusted based at least partially on the position of each of the one or more doors or windows of the vehicle at least partially open.

17. The vehicle of claim 10, wherein altering the output of the climate control system is further based at least partially on an output from a passenger compartment temperature sensor.

18. The vehicle of claim 17, wherein altering an output of the climate control system is at least partially based on one or more of an ambient temperature outside of the vehicle, a solar load in the vehicle, and/or a temperature of the passenger compartment.
